(19) United States
(12) Patent Application Publication
(10) Pub. No.: US 2025/0136109 A1
(43) Pub. Date: May 1, 2025

(54) TECHNIQUES FOR MITIGATING AUTONOMOUS VEHICLE OCCUPANT INJURIES IN A THREE-WAY LONGITUDINAL COLLISION

(71) Applicant: FCA US LLC, Auburn Hills, MI (US)

(72) Inventors: Timothy D Lenane, Royal Oak, MI (US); Michael E OBoyle, Howell, MI (US)

(21) Appl. No.: 18/499,851

(22) Filed: Nov. 1, 2023

(51) Int. Cl. B60W 30/14; B60W 30/09; B60W 30/095; B60W 30/165; B60W 60/00

(52) U.S. Cl. CPC B60W 30/143; B60W 30/09; B60W 30/0956; B60W 30/165; B60W 60/0015; B60W 2420/403; B60W 2420/408; B60W 2554/402; B60W 2554/802

(57) ABSTRACT

Three-way longitudinal collision control techniques for mitigating vehicle occupant injuries include providing a controller and a set of perception sensors configured to monitor vehicles traveling both in front of and behind a host vehicle; executing a level of autonomy three or greater (LOA 3+) autonomous driving feature that includes controlling a speed of a host vehicle relative a lead vehicle in front of the host vehicle and a trailing vehicle behind the host vehicle, during the execution of the LOA 3+ autonomous driving feature, detecting an imminent three-way longitudinal collision between the host vehicle, the lead vehicle, and the trailing vehicle, and in response to detecting the imminent three-way longitudinal collision, controlling a speed of the host vehicle during the three-way longitudinal collision to mitigate injuries to one or more occupants of the host vehicle.

### FIELD

The present application generally relates to autonomous vehicle control and, more particularly, to techniques for mitigating autonomous vehicle occupant injuries in a three-way longitudinal collision.

### BACKGROUND

In a three-way longitudinal collision, the central vehicle experiences both a front impact collision and a rear impact collision. Scholarly analysis and investigative data indicates that front impact collisions are generally more severe than rear impact collisions (i.e., they generally cause more severe vehicle occupant injuries). One particular metric that has been identified as being associated with the probability of severe injury to vehicle occupants is the change in vehicle velocity at its center of mass, also referred to as Δv. Current collision avoidance autonomous and advanced driver-assistance (ADAS) features only focus on mitigating or minimizing the front impact collision, such as via autonomous emergency braking (AEB) where vehicle braking is automatically applied based on perception system feedback. This could still result in a very significant rear impact collision and a severe vehicle occupant injury. Accordingly, while such conventional vehicle collision avoidance systems do work for their intended purpose, there exists an opportunity for improvement in the relevant art.

### SUMMARY

According to one aspect of the invention, a three-way longitudinal collision control system for mitigating vehicle occupant injuries is presented. In one exemplary implementation, the system comprises a set of perception systems configured to monitor vehicles traveling both in front of and behind a host vehicle and a controller and configured to utilize the set of perception systems to execute a level of autonomy three or greater (LOA 3+) autonomous driving feature that includes controlling a speed of the host vehicle relative a lead vehicle in front of the host vehicle and a trailing vehicle behind the host vehicle, during the execution of the LOA 3+ autonomous driving feature, detect an imminent three-way longitudinal collision between the host vehicle, the lead vehicle, and the trailing vehicle, and in response to detecting the imminent three-way longitudinal collision, control a speed of the host vehicle during the three-way longitudinal collision to mitigate injuries to one or more occupants of the host vehicle.

In some implementations, the controller is configured to control the host vehicle speed to maximize the overlap of the collision intervals between the lead vehicle and the host vehicle, and the trailing vehicle and the host vehicle, during an unavoidable three-way longitudinal collision. In some implementations, the controller is configured to control the host vehicle speed at collision with the lead and trailing vehicles in an unavoidable three-way longitudinal collision to minimize, by making equal, the probability of MAIS 3+ injuries to one or more vehicle occupants, from both the leading and trailing vehicle collisions with the host vehicle. In some implementations, the controller is configured to detect the imminent three-way longitudinal collision based on (i) a time to collision (TTC) between the host vehicle and the lead vehicle and (ii) whether an expected deceleration by the host vehicle to avoid a front-impact collision with the lead vehicle is likely to cause a rear-impact collision by the trailing vehicle with the host vehicle.

In some implementations, the controller is configured to decelerate the host vehicle during the three-way longitudinal collision to mitigate injuries to the one or more occupants of the host vehicle. In some implementations, the controller is configured to accelerate the host vehicle during the three-way longitudinal collision to mitigate injuries to the one or more occupants of the host vehicle. In some implementations, the controller is configured to both accelerate and decelerate the host vehicle during the three-way longitudinal collision to mitigate injuries to the one or more occupants of the host vehicle. In some implementations, the set of perception sensors include at least one of radio detection and ranging (RADAR) and light detection and ranging (LIDAR) sensors arranged both in the front and rear of the host vehicle. In some implementations, the set of perception sensors are further configured to detect body-type configurations of the lead vehicle and the trailing vehicle, and wherein the controller is configured to account for a body-type configuration of the host vehicle and the body-type configurations and/or relative sizes or bumper heights of the lead vehicle and the trailing vehicle in controlling the host vehicle speed to mitigate injuries to the one or more occupants of the host vehicle. In some implementations, the set of perception sensors includes front and rear facing camera systems.

According to another aspect of the invention, a three-way longitudinal collision control method for mitigating vehicle occupant injuries is presented. In one exemplary implementation, the method comprises providing a controller and a set of perception sensors utilized by the controller, the set of perception sensors being configured to monitor vehicles traveling both in front of and behind a host vehicle, executing, by the controller, an LOA 3+ autonomous driving feature that includes controlling a speed of the host vehicle relative a lead vehicle in front of the host vehicle and a trailing vehicle behind the host vehicle, during the execution of the LOA 3+ autonomous driving feature, detecting, by the controller, an imminent three-way longitudinal collision between the host vehicle, the lead vehicle, and the trailing vehicle, and in response to detecting the imminent three-way longitudinal collision, controlling, by the controller, a speed of the host vehicle during the three-way longitudinal collision to mitigate injuries to one or more occupants of the host vehicle.

In some implementations, the controlling of the host vehicle speed is performed by the controller to maximize the overlap of the collision intervals between the lead vehicle and the host vehicle, and the trailing vehicle and the host vehicle, during an unavoidable three-way longitudinal collision. In some implementations, the controlling of the host vehicle speed is performed by the controller at collision with the lead and trailing vehicles in an unavoidable three-way longitudinal collision to minimize, by making equal, the probability of MAIS 3+ injuries to one or more vehicle occupants, from both the leading and trailing vehicle collisions with the host vehicle. In some implementations, the detecting of the imminent three-way longitudinal collision is performed by the controller based on (i) a TTC between the host vehicle and the lead vehicle and (ii) whether an expected deceleration by the host vehicle to avoid a front-impact collision with the lead vehicle is likely to cause a rear-impact collision by the trailing vehicle with the host vehicle.

In some implementations, the controlling of the host vehicle speed further comprises decelerating, by the controller, the host vehicle during the three-way longitudinal collision to mitigate injuries to the one or more occupants of the host vehicle. In some implementations, the controlling of the host vehicle speed further comprises accelerating, by the controller, the host vehicle during the three-way longitudinal collision to mitigate injuries to the one or more occupants of the host vehicle. In some implementations, the controlling of the host vehicle speed comprises both accelerating and decelerating, by the controller, the host vehicle during the three-way longitudinal collision to mitigate injuries to the one or more occupants of the host vehicle. In some implementations, the set of perception sensors include at least one of RADAR and LIDAR sensors arranged both in the front and rear of the host vehicle. In some implementations, the set of perception sensors are further configured to detect body-type configurations of the lead vehicle and the trailing vehicle, and wherein the controller is configured to account for a body-type configuration of the host vehicle and the body-type configurations and/or relative sizes or bumper heights of the lead vehicle and the trailing vehicle in controlling the host vehicle speed to mitigate injuries to the one or more occupants of the host vehicle. In some implementations, the set of perception sensors includes front and rear facing camera systems.

Further areas of applicability of the teachings of the present application will become apparent from the detailed description, claims and the drawings provided hereinafter, wherein like reference numerals refer to like features throughout the several views of the drawings. It should be understood that the detailed description, including disclosed embodiments and drawings referenced therein, are merely exemplary in nature intended for purposes of illustration only and are not intended to limit the scope of the present disclosure, its application or uses. Thus, variations that do not depart from the gist of the present application are intended to be within the scope of the present application.

### BRIEF DESCRIPTION OF THE DRAWINGS

FIGS. 1A-1B are diagrams depicting an overhead view of an example three vehicle (three-way) longitudinal collision scenario according to the principles of the present application;

FIG. 1C is a plot of example data relating severe vehicle occupant injuries to vehicle speed differences (Δv) for front and rear impact collisions according to the principles of the present application;

FIG. 2 is a functional block diagram of a vehicle having an example three-way longitudinal collision control system for mitigating vehicle occupant injuries according to the principles of the present application;

FIG. 3 is a flow diagram of an example three-way longitudinal collision control method for mitigating vehicle occupant injuries according to the principles of the present application; and

FIGS. 4A-4D are diagrams illustrating an example time-to-collision (TTC) calculation results for a front-rear vehicle pair interaction similar to those used in the decision logic for the three-way longitudinal collision algorithm according to some implementations of the present application.

### DESCRIPTION

As previously discussed, current collision avoidance autonomous and advanced driver-assistance (ADAS) features only focus on mitigating or minimizing front impact collisions, such as via autonomous emergency braking (AEB) where vehicle braking is automatically applied based on perception system feedback. This could still result in a very significant rear impact collision and a severe vehicle occupant injury. Thus, while these conventional vehicle collision avoidance systems do work for their intended purpose, there exists an opportunity for improvement in the relevant art. Accordingly, improved three-way longitudinal collision control systems and methods for mitigating vehicle occupant injuries are presented herein. These techniques utilize autonomous/ADAS control (i.e., longitudinal speed control), including existing front/rear perception systems, to mitigate vehicle occupant injuries during three-way longitudinal collisions. Potential benefits of these techniques include improved vehicle safety ratings and decreased amounts/severity of vehicle occupant injuries.

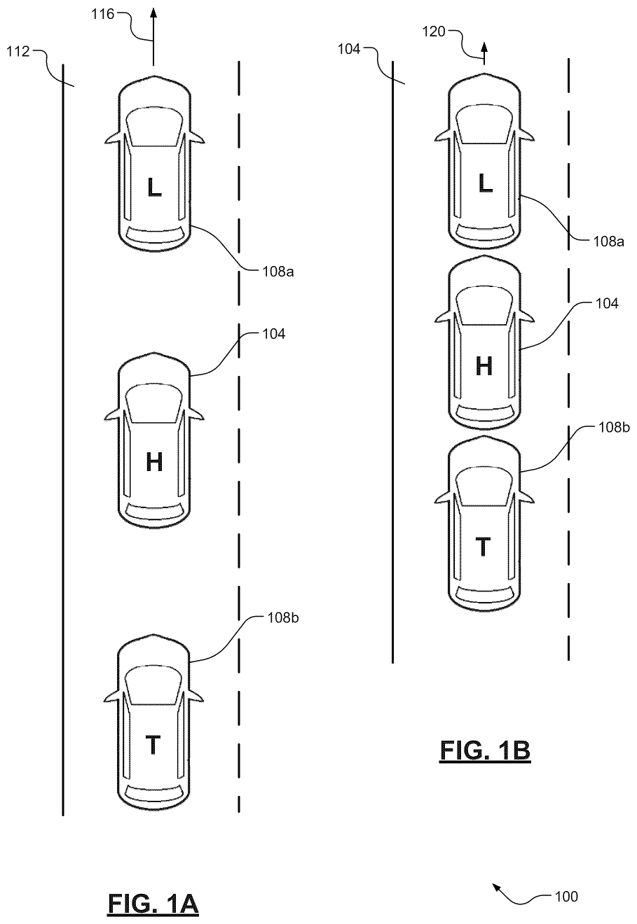

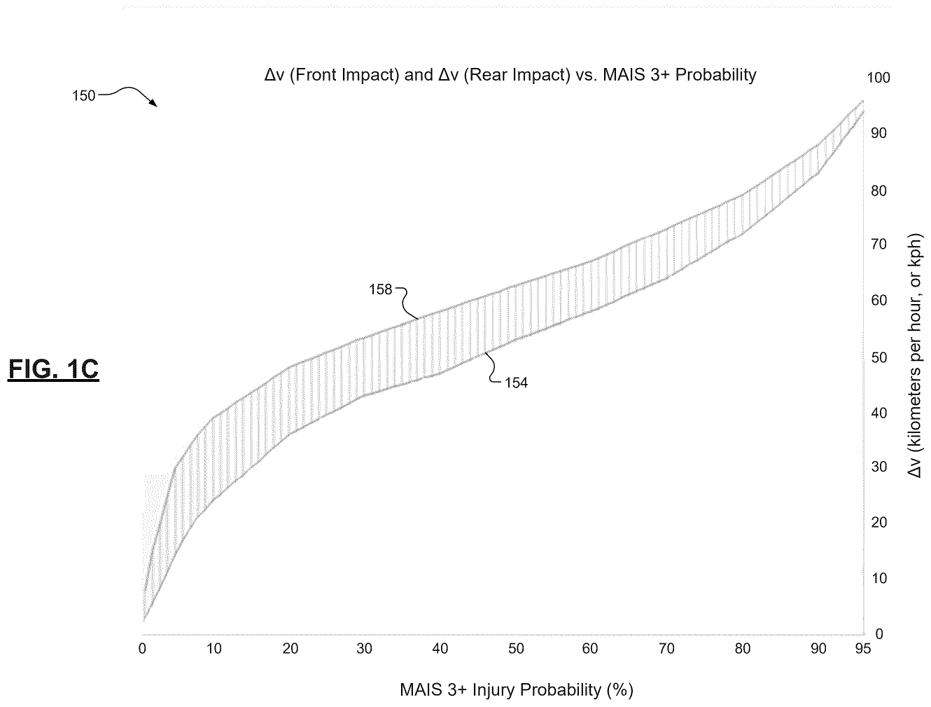

Referring now to FIGS. 1A-1B, diagrams depicting an overhead view of an example three vehicle (three-way) longitudinal collision scenario 100 according to the principles of the present application is illustrated. As shown, a central or host vehicle (H) 104 is traveling between a lead vehicle (L) 108a and a trailing vehicle (T) 108b along a roadway lane 112 in a particular direction/speed as indicated by arrow/vector 116. In FIG. 1A, the vehicles 104, 108a, and 108b are spaced apart such that no collisions are imminent. In FIG. 1B, the lead vehicle 108a has drastically slowed down as indicated by arrow/vector 120, which causes the following vehicles 104 and 108b to enter into a three-way collision with the lead vehicle 108a. It will be appreciated that this is merely an example scenario for illustrative purposes. Based on goals/targets, autonomous/ADAS control of the longitudinal speed of the host/central vehicle 104 is performed during the three-way longitudinal collision scenario to mitigate vehicle occupant injuries.

Referring now to FIG. 1C, a plot 150 of example data relating severe vehicle occupant injuries to vehicle speed differences (Δv) for front and rear impact collisions 154 and 158, respectively, according to the principles of the present application. The x-axis of this plot 150 shows a probability (%) of a maximum abbreviated injury scale (MAIS) level three or greater (MAIS 3+) vehicle occupant injury occurring from the impact collision. As previously discussed, one particular metric that has been identified as being associated with the probability of severe injury to vehicle occupants is the change in vehicle velocity at its center of mass, also referred to as Δv. The goal of the techniques of the present application is two-fold. First, an overlapping or simultaneous three-way impact collision is associated with less severe vehicle occupant injuries compared to separate or distinct front and rear impact collisions (e.g., one collision followed by another). Second, because there is a higher probability of MAIS 3+ injury for a front impact versus a rear impact, with the same Δv value, it follows that the probability of MAIS 3+ injury will be the same if the Δv at collision for a rear impact is larger than the Δv at collision for a front impact.

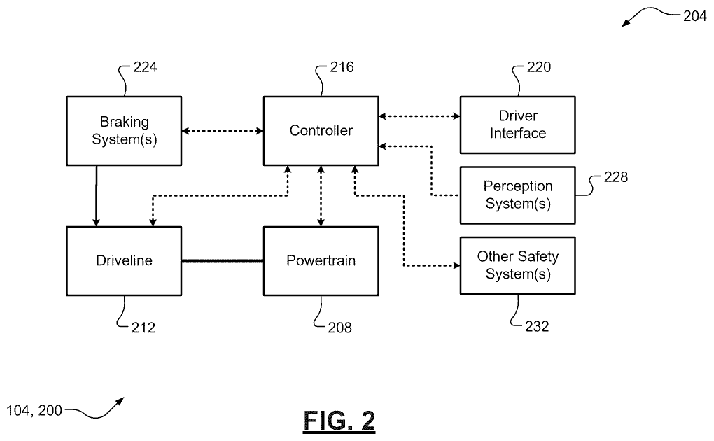

Referring now to FIG. 2, a functional block diagram of a vehicle 200 having an example three-way longitudinal collision control system 204 for mitigating vehicle occupant injuries according to the principles of the present application is illustrated. The vehicle 200 generally comprises a powertrain 208 configured to generate and transfer drive torque to a driveline 212 for vehicle propulsion. A controller 216 controls operation of the vehicle 200, including performing at least a portion of the techniques of the present application, which are described in greater detail below. The controller 216 primarily controls the powertrain 208 to generate and transfer a desired amount of drive torque to the driveline 212 to satisfy a torque request, which could be provided by the driver via a driver interface 220 (e.g., an accelerator pedal). The controller 216 is also configured to decelerate or slow the vehicle 200 by controlling one or more braking systems 224 (hydraulic brakes, a regenerative braking system, etc.) to apply friction to the driveline 212.

The controller 216 is also configured to execute a variety of autonomous or ADAS driving features (hereinafter, “autonomous driving features” for simplicity). This can include different levels of autonomy (LOA) control ranging from level 0 (L0) up to L4 (semi-autonomous) or L5 (fully-autonomous control. In particular, the techniques of the present application focus on LOA 3+ autonomous driving features where the speed/distance to leading and trailing vehicles is monitored and the speed/acceleration of the vehicle 200 is thereby adjusted automatically (i.e., without driver intervention via the driver interface 220). For a vehicle equipped to perform LOA 3+, the three-way longitudinal collision strategy, which is the subject of this disclosure, could be made available while the adaptive cruise control (ACC) function is providing longitudinal control. The vehicle 200 further comprises a set of perception systems 228 and a set of other safety systems 232 (seatbelts, airbags, etc.)

As part of the LOA 3+ autonomous operation, the controller 216 is configured to utilize the set of perception systems 228 to maintain desired distances or gaps between the vehicle 200 and lead/trailing vehicles. The set of perception systems 228 could include radio detection and ranging (RADAR) sensors and/or light detection and ranging (LIDAR) sensors configured to detect nearby objects (e.g., vehicles) and distances thereto. In some implementations, the set of perception systems 228 could also include front and rear facing camera systems configured to detect nearby objects and their types/classes (e.g., body-type configurations of the lead and trailing vehicles). The controller 216 could then utilize this information to account for a body-type configuration of the vehicle (e.g., pickup truck) and the body-type configurations of the lead and trailing vehicles (e.g., four door sedans) in controlling the vehicle speed to mitigate injuries to the one or more occupants of the vehicle 200.

The controller 216 is also configured to detect an imminent three-way longitudinal collision scenario. When detected, the controller 216 is configured to control the vehicle speed at collision with front and rear vehicles, in such a way as to make equal, the MAIS 3+ vehicle occupant injury probability for both the front-impact and rear-impact collisions. The difference in the probability of MAIS 3+ injury between front and rear collisions for a given value Δv at collision, is depicted in the plot 150 of FIG. 1C as 154 (front collision) and 158 (rear collision). If the speed at collision with front and rear vehicles is modified to make equal the probability of MAIS 3+ injury resulting from the front and rear collisions, then the front impact will not be more dangerous than the rear impact and vice versa. Since neither the front nor the rear impact will result in a higher probability of MAIS 3+ injuries to the occupants of the vehicle, then the overall resulting injuries to the vehicle occupants is minimized. The magnitude of the vertical segments drawn between 158 (rear collisions) and 154 (front collisions) in the plot 150 of FIG. 1C represent the difference in Δv between front and rear collisions for the same value of MAIS 3+ injury probability. Plot 150 of FIG. 1C, containing plots 154 and 158 reveal that for front and rear collisions having equal MAIS 3+ injury probability, the Δv at collision for front collisions (plot 154) is less than the Δv at collision for rear collisions (plot 158) across the entire range of MAIS 3+ injury probabilities.

Throughout the entire range of MAIS 3+ injury probabilities, the magnitude of the vertical segment drawn between plot 158 and plot 154 represents the additional Δv value that would need to be added to the value of Δv (front collision) to create a Δv (rear collision) having same MAIS 3+ injury probability as the front collision. The information for front and rear Δv at collision versus MAIS 3+ injury probability contained in plots 150, 154 and 158 of FIG. 1C, could be stored, for example, in a lookup table stored in a memory of the controller 216. Further, when such a scenario is detected, the controller 216 is configured to control the vehicle speed to maximize the overlap of the collision intervals between lead vehicle and vehicle and trailing vehicle and vehicle during an unavoidable three-way longitudinal collision. When collisions are simultaneous, ideally, or have a large time overlap, then from the vehicle frame-of-reference, there is partial cancellation of the oppositely directed force vectors from the front vehicle collision and the rear vehicle collision, and the magnitude of the net force acting on the vehicle is minimized.

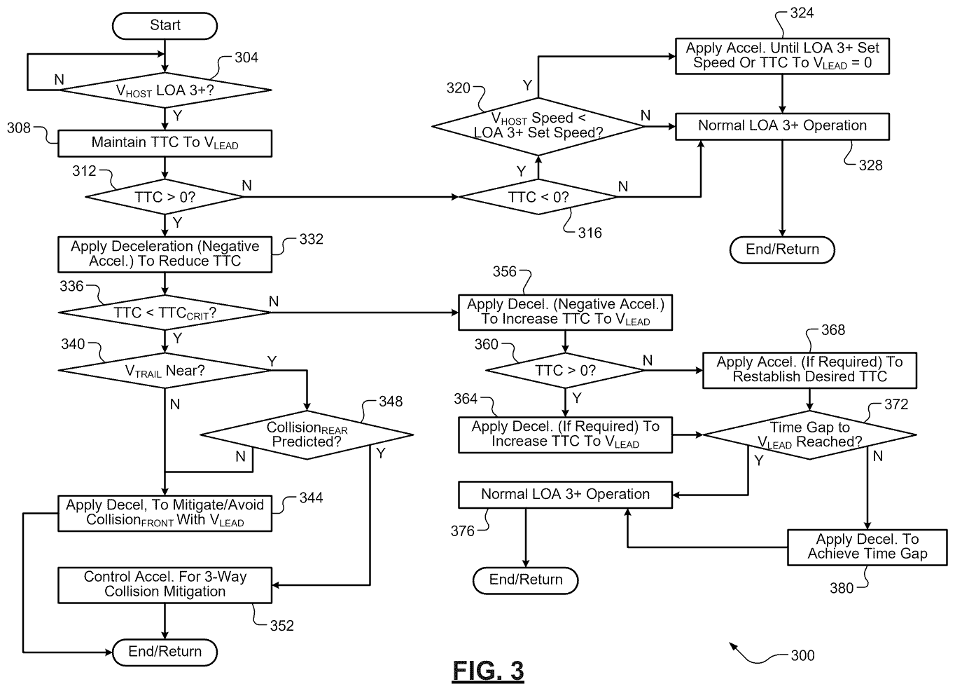

Referring now to FIG. 3, a flow diagram of an example three-way longitudinal collision control method 300 for mitigating vehicle occupant injuries according to the principles of the present application is illustrated. While the vehicle 200 and its components are specifically referenced for illustrative/descriptive purposes, it will be appreciated that this method 300 could be applicable to any suitably configured vehicle. At 304, the controller 216 determines whether the vehicle 200 (also referred to as the “host vehicle 200” or “V_{HOST}”) is currently executing a LOA 3+ autonomous driving feature. When false, the method 300 ends or returns to 304. When true, the method 300 proceeds to 308. At 308, the controller 216 maintains a time to collision (TTC) to the lead vehicle (“V_{LEAD}”) according to the LOA 3+ autonomous driving feature. At 312, the controller 216 determines whether the TTC is greater than zero. When true, the method 300 proceeds to 332. When false, the method 300 proceeds to 316.

At 316, the controller 216 determines whether the TTC is less than zero. When false (i.e., when the TTC equals zero or is within a threshold amount of zero), the method 300 proceeds to 328. When true, the method 300 proceeds to 320. At 320, the controller 216 determines whether the speed of the vehicle 200 is less than a set/desired speed for the LOA 3+ autonomous feature. When false, the method 300 proceeds to 328. When true, the method 300 proceeds to 324. At 324, the controller 216 accelerates the vehicle 200 until the LOA 3+ set/desired speed is reached or until TTC to the lead vehicle equals zero, whichever occurs first. The method 300 then proceeds to 328. At 328, the controller 216 continues or resumes normal LOA 3+ operation and the method 300 then ends or returns to 304. At 332 (when step 312 is true), the controller 216 decelerates the vehicle 200 to reduce the TTC to the lead vehicle. At 336, the controller 216 determines whether the TTC is less than a critical TTC (TTC_{CRIT}), which could be approximately but slightly greater than zero. When true, the method 300 proceeds to 340. When false, the method 340 proceeds to 356.

At 340, the controller 216 determines whether a trailing vehicle (“V_{TRAIL}”), if present, is nearby. This could be determined, for example, based on distance measurements/estimates to the trailing vehicle (e.g., nearby meaning less than a threshold distance away). When false, the method 300 proceeds to 344. When true, the method 300 proceeds to 348. At 344, the controller 216 decelerates the vehicle to mitigate or avoid a front-impact collision (Collision_{FRONT}) with the lead vehicle and the method 300 then ends or returns to 304. At 348, the controller 216 determines whether a rear-impact collision (Collision_{REAR}) is predicted based on the current operating conditions. When false, the method 300 proceeds to 344. When true, the method 300 proceeds to 352 where the controller 216 accelerates (and/or decelerates) the vehicle 200 during the three-way vehicle collision to mitigate occupant injuries according to the techniques of the present application and the method 300 then ends or returns to 304.

At 356, the controller 216 decelerates the vehicle 200 to increase the TTC to the lead vehicle. At 360, the controller 216 determines whether the TTC to the lead vehicle is greater than zero. When true, the method 300 proceeds to 364. When false, the method 300 proceeds to 368. At 364, the controller 216 decelerates the vehicle (if required) to increase the TTC to the lead vehicle and the method 300 then proceeds to 372. At 368, the controller 216 accelerates the vehicle 200 (if required) to reestablish the desired/target TTC to the lead vehicle and the method 300 then proceeds to 372. At 372, the controller 216 determines whether a time gap to the lead vehicle has been reached. When the time gap has been reached, the method 300 proceeds to 376. When false, the method 300 proceeds to 380. At 376, the controller 216 continues or resumes normal LOA 3+ operation and the method 300 then ends or returns to 304. At 380, the controller 216 decelerates the vehicle 200 to achieve the time gap and the method 300 then proceeds to 376.

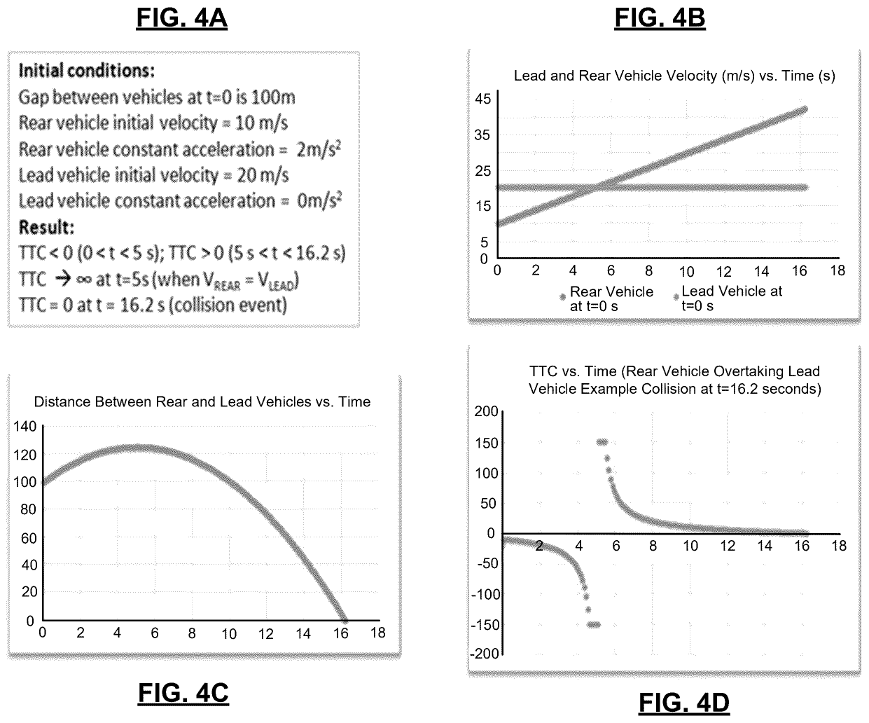

Referring now to FIGS. 4A-4D, an example of the time-to-collision (TTC) counter concept used in the three-way longitudinal collision algorithm of the present application (e.g., FIG. 3 above) is shown and is discussed in greater detail below. Evaluations of the TTC counters to front and rear vehicles determine if and when the three-way longitudinal collision algorithm logic is implemented. In the figures, TTC is plotted as a function of time versus is a function of the (a) distance between vehicles and (b) vehicles relative speeds to one another. Assuming that the vehicles are travelling in the same direction and following the same straight path, TTC is calculated by the following formula:

$${T}_{TTC} = [ {X}_{L E A D} ( t ) - {X}_{TRAIL} ( t ) ] / [ {V}_{TRAIL} ( t ) - {V}_{LEAD} ( t ) ] ,$$

Where X_{LEAD}(t) is the position lead vehicle at time=t, X_{TRAIL}(t) is the position trailing vehicle at time=t, V_{LEAD}(t) is the velocity of the trailing vehicle at time=t, and V_{TRAIL}(t) is the velocity of the trail vehicle at time=t.

By applying the above equation: T_{TTC} is positive and finite when a trailing vehicle is overtaking, but still trailing, a lead vehicle (V_{TRAIL}>V_{LEAD} and X_{TRAIL}<X_{LEAD}); T_{TTC} is negative and finite when a lead vehicle is pulling away from a trailing vehicle (V_{LEAD}>V_{TRAIL} and X_{LEAD}>X_{TRAIL}); T_{TTC} is zero at the moment trailing vehicle impacts lead vehicle (V_{LEAD} #V_{TRAIL} and X_{TRAIL}=X_{LEAD}); T_{TTC} approaches positive infinity if the trailing vehicle velocity has been increasing and now equals that of the lead vehicle (V_{LEAD}=V_{TRAIL} and X_{TRAIL}<X_{LEAD}); and T_{TTC} approaches negative infinity if the difference between lead vehicle velocity and trailing vehicle velocity decreases until the trailing vehicle velocity is equal to that of the lead vehicle (V_{LEAD}=V_{TRAIL} and X_{TRAIL}<X_{LEAD}).

It will be appreciated that the term “controller” as used herein refers to any suitable control device or set of multiple control devices that is/are configured to perform at least a portion of the techniques of the present application. Non-limiting examples include an application-specific integrated circuit (ASIC), one or more processors and a non-transitory memory having instructions stored thereon that, when executed by the one or more processors, cause the controller to perform a set of operations corresponding to at least a portion of the techniques of the present application. The one or more processors could be either a single processor or two or more processors operating in a parallel or distributed architecture.

It should also be understood that the mixing and matching of features, elements, methodologies and/or functions between various examples may be expressly contemplated herein so that one skilled in the art would appreciate from the present teachings that features, elements and/or functions of one example may be incorporated into another example as appropriate, unless described otherwise above.

What is claimed is:

1. A three-way longitudinal collision control system for mitigating vehicle occupant injuries, the system comprising:
a set of perception systems configured to monitor vehicles traveling both in front of and behind a host vehicle; and
a controller and configured to utilize the set of perception systems to:
execute a level of autonomy three or greater (LOA 3+) autonomous driving feature that includes controlling a speed of the host vehicle relative a lead vehicle in front of the host vehicle and a trailing vehicle behind the host vehicle;
during the execution of the LOA 3+ autonomous driving feature, detect an imminent three-way longitudinal collision between the host vehicle, the lead vehicle, and the trailing vehicle; and
in response to detecting the imminent three-way longitudinal collision, control a speed of the host vehicle during the three-way longitudinal collision to mitigate injuries to one or more occupants of the host vehicle.

2. The system of claim 1, wherein the controller is configured to control the host vehicle speed to maximize the overlap of the collision intervals between the lead vehicle and the host vehicle, and the trailing vehicle and the host vehicle, during an unavoidable three-way longitudinal collision.

3. The system of claim 2, wherein the controller is configured to control the host vehicle speed at collision with the lead and trailing vehicles in an unavoidable three-way longitudinal collision to minimize, by making equal, the probability of MAIS 3+ injuries to one or more vehicle occupants, from both the leading and trailing vehicle collisions with the host vehicle.

4. The system of claim 1, wherein the controller is configured to detect the imminent three-way longitudinal collision based on (i) a time to collision (TTC) between the host vehicle and the lead vehicle and (ii) whether an expected deceleration by the host vehicle to avoid a front-impact collision with the lead vehicle is likely to cause a rear-impact collision by the trailing vehicle with the host vehicle.

5. The system of claim 1, wherein the controller is configured to decelerate the host vehicle during the three-way longitudinal collision to mitigate injuries to the one or more occupants of the host vehicle.

6. The system of claim 1, wherein the controller is configured to accelerate the host vehicle during the three-way longitudinal collision to mitigate injuries to the one or more occupants of the host vehicle.

7. The system of claim 1, wherein the controller is configured to both accelerate and decelerate the host vehicle during the three-way longitudinal collision to mitigate injuries to the one or more occupants of the host vehicle.

8. The system of claim 1, wherein the set of perception sensors include at least one of radio detection and ranging (RADAR) and light detection and ranging (LIDAR) sensors arranged both in the front and rear of the host vehicle.

9. The system of claim 1, wherein the set of perception sensors are further configured to detect body-type configurations of the lead vehicle and the trailing vehicle, and wherein the controller is configured to account for a body-type configuration of the host vehicle and the body-type configurations and/or relative sizes or bumper heights of the lead vehicle and the trailing vehicle in controlling the host vehicle speed to mitigate injuries to the one or more occupants of the host vehicle.

10. The system of claim 9, wherein the set of perception sensors includes front and rear facing camera systems.

11. A three-way longitudinal collision control method for mitigating vehicle occupant injuries, the method comprising:
providing a controller and a set of perception sensors utilized by the controller, the set of perception sensors being configured to monitor vehicles traveling both in front of and behind a host vehicle;
executing, by the controller, a level of autonomy three or greater (LOA 3+) autonomous driving feature that includes controlling a speed of the host vehicle relative a lead vehicle in front of the host vehicle and a trailing vehicle behind the host vehicle;
during the execution of the LOA 3+ autonomous driving feature, detecting, by the controller, an imminent three-way longitudinal collision between the host vehicle, the lead vehicle, and the trailing vehicle; and
in response to detecting the imminent three-way longitudinal collision, controlling, by the controller, a speed of the host vehicle during the three-way longitudinal collision to mitigate injuries to one or more occupants of the host vehicle.

12. The method of claim 11, wherein the controlling of the host vehicle speed is performed by the controller to maximize the overlap of the collision intervals between the lead vehicle and the host vehicle, and the trailing vehicle and the host vehicle, during an unavoidable three-way longitudinal collision.

13. The method of claim 12, wherein the controlling of the host vehicle speed is performed by the controller at collision with the lead and trailing vehicles in an unavoidable three-way longitudinal collision to minimize, by making equal, the probability of MAIS 3+ injuries to one or more vehicle occupants, from both the leading and trailing vehicle collisions with the host vehicle.

14. The method of claim 11, wherein the detecting of the imminent three-way longitudinal collision is performed by the controller based on (i) a time to collision (TTC) between the host vehicle and the lead vehicle and (ii) whether an expected deceleration by the host vehicle to avoid a front-impact collision with the lead vehicle is likely to cause a rear-impact collision by the trailing vehicle with the host vehicle.

15. The method of claim 11, wherein the controlling of the host vehicle speed further comprises decelerating, by the controller, the host vehicle during the three-way longitudinal collision to mitigate injuries to the one or more occupants of the host vehicle.

16. The method of claim 11, wherein the controlling of the host vehicle speed further comprises accelerating, by the controller, the host vehicle during the three-way longitudinal collision to mitigate injuries to the one or more occupants of the host vehicle.

17. The method of claim 11, wherein the controlling of the host vehicle speed comprises both accelerating and decelerating, by the controller, the host vehicle during the three-way longitudinal collision to mitigate injuries to the one or more occupants of the host vehicle.

18. The method of claim 11, wherein the set of perception sensors include at least one of radio detection and ranging (RADAR) and light detection and ranging (LIDAR) sensors arranged both in the front and rear of the host vehicle.

19. The method of claim 11, wherein the set of perception sensors are further configured to detect body-type configurations of the lead vehicle and the trailing vehicle, and wherein the controller is configured to account for a body-type configuration of the host vehicle and the body-type configurations and/or relative sizes or bumper heights of the lead vehicle and the trailing vehicle in controlling the host vehicle speed to mitigate injuries to the one or more occupants of the host vehicle.

20. The method of claim 19, wherein the set of perception sensors includes front and rear facing camera systems.
